(19) United States
(12) Patent Application Publication
(10) Pub. No.: US 2014/0258030 A1
(43) Pub. Date: Sep. 11, 2014

(54) METHOD AND SYSTEM OF AN AUTHENTIC TRANSLATION OF A PHYSICAL TRADESHOW

(71) Applicant: Balluun AG, Zurich (CH)

(72) Inventors: Peter Koch, Foster City, CA (US); David Tso, Fremont, CA (US)

(73) Assignee: Balluun AG, Zurich (CH)

(21) Appl. No.: 14/205,278

(22) Filed: Mar. 11, 2014

Related U.S. Application Data
(63) Continuation-in-part of application No. 13/197,669, filed on Aug. 3, 2011.
(60) Provisional application No. 61/801,636, filed on Mar. 15, 2013.

(51) Int. Cl. G06Q 30/06; G06Q 50/00

(52) U.S. Cl. CPC G06Q 30/0643; G06Q 50/01
USPC 705/26.8; 705/27.2

(57) ABSTRACT

A method and system of an authentic translation of a physical tradeshow wholesale buying experience into a web/mobile application service are provided. The web/mobile application service may provide enhanced and streamlined interactions between sales representatives and retail buyers and also may include product bookmarking, re-stocking planning and a mass purchase order creation service. The system may utilize a business to business (B2B) marketplace and social networking in the B2B marketplace.

### PRIORITY CLAIM/RELATED APPLICATION

This application claims the benefit under 35 USC 119(e) and 120 to U.S. Provisional Patent Application Ser. No. 61/801,636, filed Mar. 15, 2013 and titled “Method And System Of An Authentic Translation Of A Physical Tradeshow” and also claims priority under 35 USC 120 and is a continuation in part of U.S. patent application Ser. No. 13/197,669 (“'669 Application”) filed on Aug. 3, 2011, which are both incorporated herein by reference.

### APPENDIX

Appendix A (48 pages) contains examples of the user interface of an authentic translation of a tradeshow experience.

Appendix A forms a part of the specification and are hereby incorporated herein by reference.

### FIELD

The disclosure relates generally to a method and system of an authentic translation of a physical tradeshow wholesale buying experience but enhanced and streamlined between sales representatives and retail buyers onto an web/mobile application service.

### BACKGROUND

The wholesale trade experience between manufacturer/brands and retailer/boutiques still depends to a very large degree on physical trade shows. The major trade shows for a given industry are usually in a couple major cities within the US and in a few major cities somewhere internationally (Tokyo, Berlin, Paris, etc). To attend trade shows, brands/manufacturer have to rent booth spaces and travel employees to the shows, also shipping costs for booth material, merchandise, samples are expensive. Each brand/manufacturer exhibits their merchandise in open booth spaces at the tradeshow location viewable by interested retailer walking by or closed booth spaces only allowing invited retailers to enter.

Retailers having their stores all across the country/world, even from the smallest towns, have to travel to the major cities to be able to meet with vendors around 1-10 times a year. The retailers (retail buyer/owner) usually either make pre-arranged meetings with specific vendors on the trade show floor, or walking the floor passing booth spaces and scan potential new vendors and merchandise at the show floor. The travel effort is taxing and expensive, especially since the economic downturn in 2008 that has caused a retailer to struggle to be able to go to all the tradeshows due to: 1) the expenses; and 2) the turnaround in their stores has not been fast enough to have enough cash flow to restock. However, the retailer needs to participate in the marketplace to see trends and buy a basic set of new merchandise, but currently are having to financially strain themselves to do so.

A few ‘large’ retail chains, such as Nordstrom, Neiman Marcus, Macys, etc, make appointments with their vendors at the tradeshow, meet new vendors and usually take orders back to their office through their EDI integrated order system. As a result, each new vendor must invest in an EDI integration with every individual large retail chain before being able to receive orders in this manner.

The majority of the market participants in the retail space, however, are small to mid size retailers and brands/manufacturers in most industries. For example, industries with a very large and diverse market participations by small to mid size businesses include the Fashion Industry, Accessory industry, gift industry, houseware industry and sport industry to take a view (this list is not limited to these but just represent an example of industries). The industries may not include large automobile shows of car vendors, but certainly would include the motorcycle supply industry and the car supply industry.

Retailers at the trade shows are get information, taking product print material and are taking notes. For example, orders from the many small to mid size vendors are, for the most part, taken on paper purchase order forms even today. However, it would be desirable to streamline the process of showing merchandise, getting informed, taking notes, discussion with coworkers, plan merchandising and creating purchase orders in one single application without the hassle of notes in paper note books or on random pieces of paper.

Online wholesale ordering tools are on the rise, nevertheless the authentic experience is missing in most solutions. Usually, the online system is a non-collaborative online ordering system that does not offer the collaborative nature of a real tradeshow, is a complete vendor proprietary solution without the tradeshow character, is limited to the order taking or is missing the privacy requirements wholesale ordering requires. In addition, these online solutions are not offering choices to memorize products, organize merchandise by vendors, nor allowing the retailer to simply browse through the marketplace for other merchandise in addition to the prominent collections their vendors are offering. But it would be desirable to have a system, which incorporates and compliments the offline tradeshow experience, either at the show or through vendor/buyer engagement away from the show to improve the workflow and the engagement with coworkers and vendors while preparing the order flow using an integrated mobile/web app.

While tradeshow floor maps (mobile or print) are not new and independent planning tools exist, those tradeshow floor maps do not allow collaboration around merchandising to occur. Furthermore, the tradeshow workflow process is currently done manually with lots of handwritten notes in addition to leaflets/product brochures/linesheets and paper notebooks. Some tradeshow tools might have a profile showing products and other tradeshow tools may offer secure logins for some buyers but not for others, but wholesale ordering is still a standalone service. What all of these systems are missing is the integrated approach of addressing the “at the show” requirements for buyer and seller, but also cover the all year around requirements for taking orders, managing orders and invoices across all vendors in one single application.

### BRIEF DESCRIPTION OF THE DRAWINGS

FIG. 1 illustrates a social business to business (B2B) network marketplace platform that may implement a tradeshow component;

FIG. 2 is a more detailed view of the social business to business (B2B) network marketplace of one private b2b network that may implemented the tradeshow component system and method;

FIG. 3 is a block diagram of a social marketplace unit that is used to manage the social business to business (B2B) marketplace and may implement the tradeshow component system and method;

FIG. 4 illlustrates an example of a configuration of a virtual tradeshow including a retailer home page and an industry focused brand page that may be implemented using the tradeshow component and the social business to business (B2B) network marketplace;

FIG. 5 illlustrates an example of a configuration of a virtual tradeshow including a retailer linesheet overview and an industry focused collection page that may be implemented using the tradeshow component and the social business to business (B2B) network marketplace;

FIGS. 6A-6C illustrate examples of a virtual tradeshow user interface including open booth spaces, closed up booth spaces and a layout map of the virtual tradeshow, respectively;

FIG. 7 illustrates an example of a single booth space at a virtual tradeshow that may be implemented on a mobile application;

FIG. 8 illustrates a wholesale order planning and buying method that may be implemented using the tradeshow component and the social business to business (B2B) network marketplace;

FIG. 9 illlustrates an example of a configuration of a virtual tradeshow including a dashboard and a shop by brand page that may be implemented using the tradeshow component and the social business to business (B2B) network marketplace;

FIG. 10 illustrates a tradeshow workflow in the social business to business (B2B) network marketplace using a mobile application;

FIG. 11 illustrates another tradeshow workflow in the social business to business (B2B) network marketplace using a mobile application;

FIG. 12 illustrates a tradeshow workflow in the social business to business (B2B) network marketplace using a web application; and

FIG. 13 illustrates another tradeshow workflow in the social business to business (B2B) network marketplace using a web application.

### DETAILED DESCRIPTION OF ONE OR MORE EMBODIMENTS

The disclosure is particularly applicable to an electronic tradeshow system and method implemented with a Balluun™ social business to business (B2B) network marketplace and it is in this context that the disclosure will be described. It will be appreciated, however, that the system and method may be implemented in other manners that are within the scope of the disclosure. The system and the tradeshow system may be used to buy or sell various items. The items may be services, retail goods, fashion goods, clothing, consumer goods and the like.

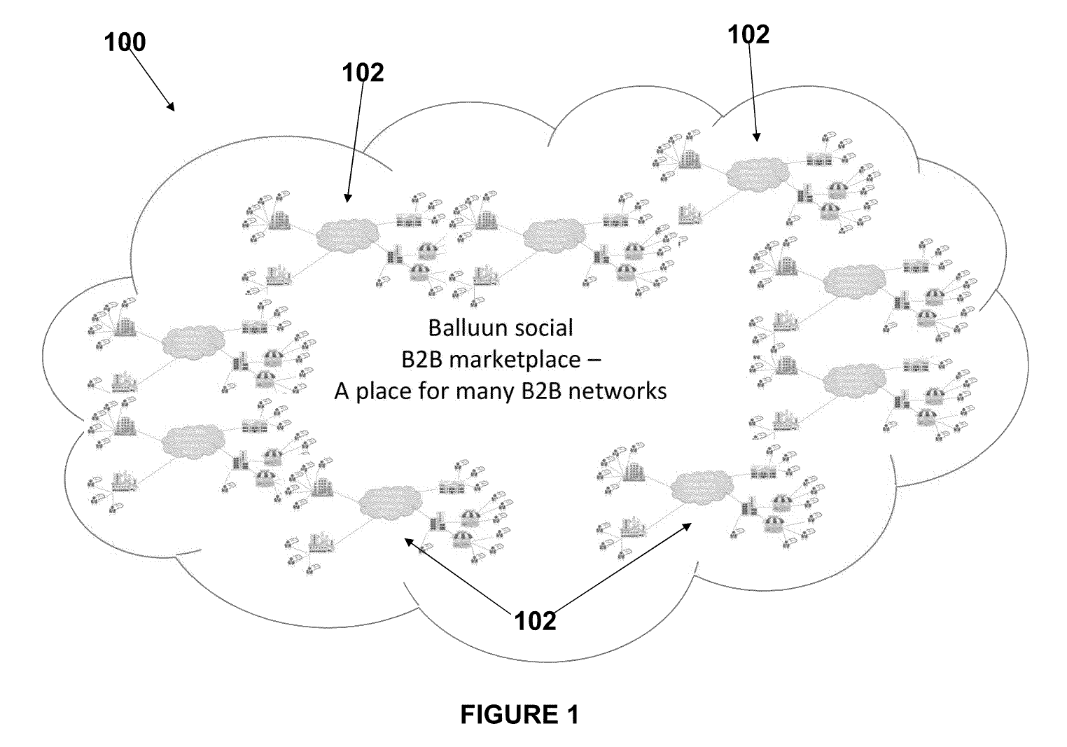

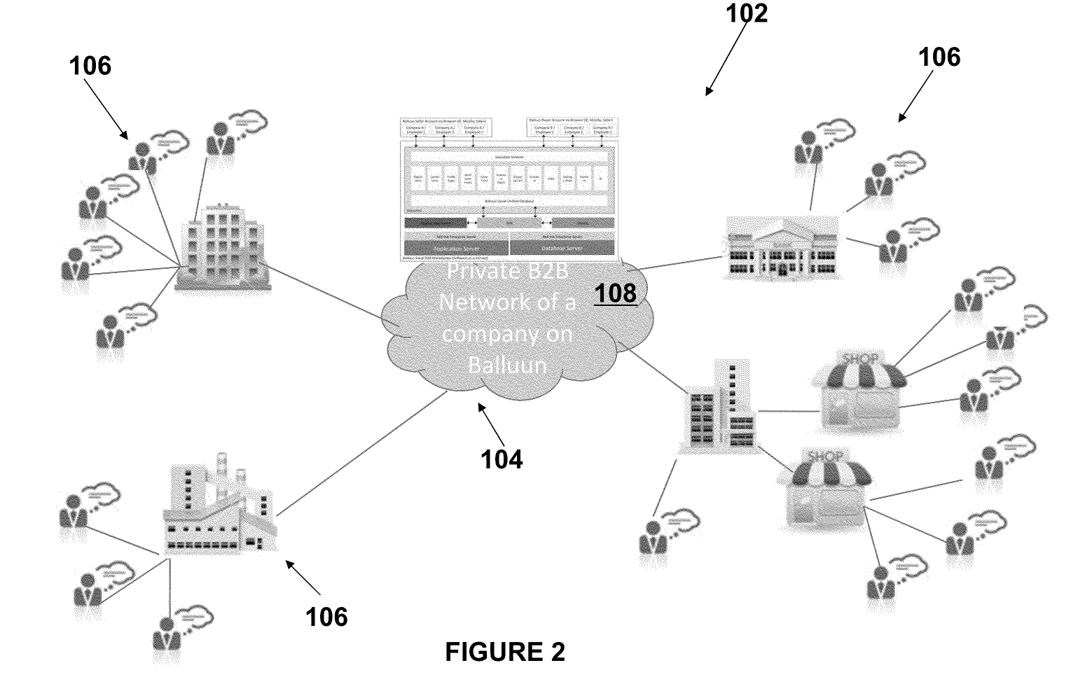

FIG. 1 illustrates a social business to business (B2B) network marketplace 100 in which a plurality of social B2B networks 102 (that may be typical B2B networks or other types of B2B market networks) are brought together with a social aspect (described below) to facilitate social interactions between the participants in each of the social B2B market networks 102 and between one participants and other participants. FIG. 2 is a more detailed view of a social business to business (B2B) network and in particular illustrates an example of one social B2B network 102 shown in FIG. 1. Each social B2B network 102 has a social network marketplace unit and connections/links 104 that interconnects one or more participants 106 in a private B2B network 108. When each social B2B market network 102 is connected to each other in the social business to business (B2B) marketplace 100, the dedicated private networks 102 are maintained, but a public forum (which each participant to opt to participate in at various levels) is also created that allows social interaction using the social network marketplace unit and connections/links 104 while maintaining the private B2B networks 102 as described below in more detail.

The resulting system 100 provides multilevel feeding of social interaction and conversations including: a business to many other business conversation/activity (public and private), a intra company conversation/activity using the private B2B network, a person to person or person to many person conversion/activity within a private network, a private business to business conversion/activity over a private network, a private business to business personal conversion/activity over a private network, a private business to business object related conversation/activity using a private B2B network about goods/services being negotiated, bought or sold, a private business to business object related conversation using a private B2B network about business opportunities, a private business to business object related conversation using a private B2B network about a service/good order, a private business to business object related conversation using a private B2B network about managing a goods/services order and/or a private business to business object related conversation using a private B2B network about customer service. Each of these different types of conversions/interactions are facilitated by the system and method that are now described in more detail. Also a private message system spanning across the connected companies to communicate in a private messaging style (similar to Facebook or linkedin's messaging service) is also enabled allowing participants to write private messages beside the social feed by utilizing the social b2b relationship.

The social B2B network marketplace system provides beside a storefront concept for seller companies to sell and buyer companies to buy a microblogging capability to all participants of the social marketplace B2B system. The microblogging capability allows the participants to have the communications, engagement, collaboration, activity and conversations above with each other. The systems and units that enable the microblogging are now described in more detail.

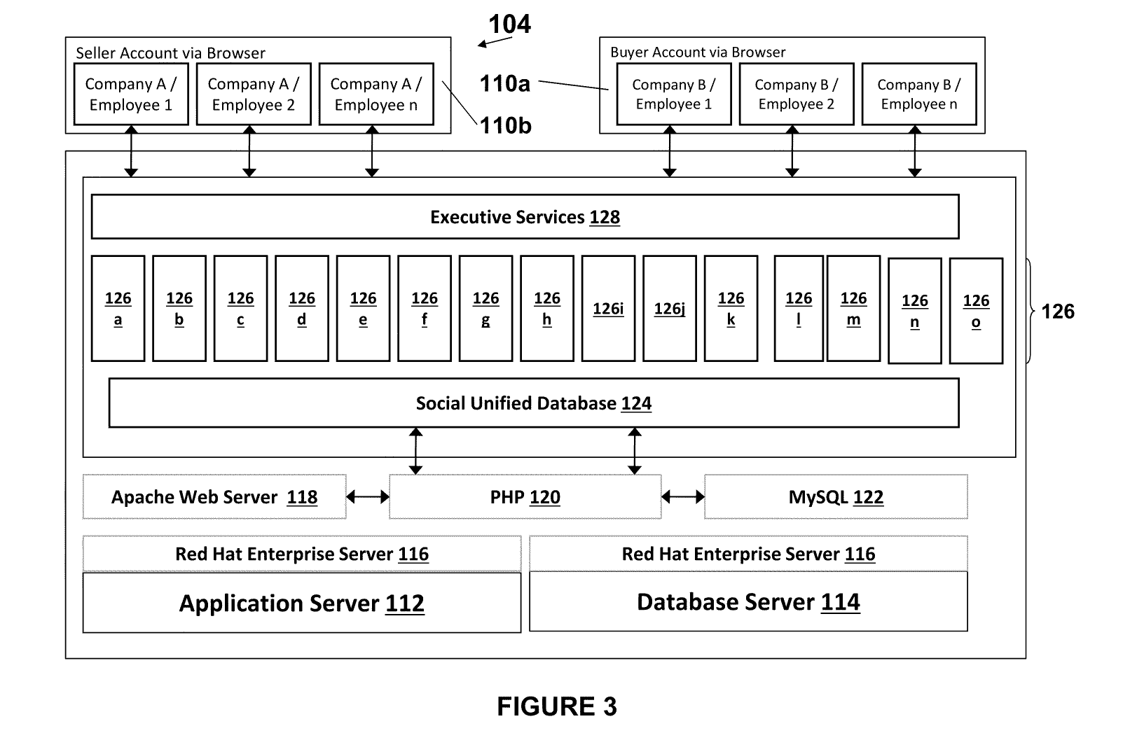

FIG. 3 is a block diagram of a social marketplace unit 104 that is used to manage the social business to business (B2B) network marketplace. One or more computing devices 110 (such as a seller account computing device 110b and a buyer account computing device 110a) can connect to the social marketplace unit 104 using well known protocols (whether secure or not) over a link that may be wired or wireless. In some embodiment, each seller account may be accessed by one or more employees of the seller (employee1, employee2, . . . , employee n) and each employee may have their own computing device 110. Similarly, each buyer account may be accessed by one or more employees (employee1, employee2, . . . , employee n) of the buyer and each employee may have their own computing device 110. Thus, the social marketplace unit 104 can be connected to by a plurality of sellers and buyers and a plurality of computing devices 110. Each computing device 110 may be a processing unit based device with a display, processing power and memory to be able to interact with the social marketplace unit 104. For example, each computing device may be a personal computer, a tablet computer, such as the Apple iPad, a terminal, a laptop computer, a smartphone (Apple iPhone, RIM Blackberry device, HTC device or Palm device), a mobile phone with a digital data capability, a tablet computer and the like. In one embodiment, the computing device has an operating system and manages the functioning of the computing device and the computing device may also have a well known browser application (Mozilla, Safari, etc.) that is stored in the memory of the computing device and executed by a processor of the computing device to establish a connection with the social marketplace unit 104 and interact with the social marketplace unit 104 by exchanging data, images, video, web pages and the like.

The social marketplace unit 104 may further comprise one or more well known application servers 112 with one or more well known database servers 114 for scalability, troubleshooting and security reasons. The above components also provide load balancing as is known. In one embodiment, both the database and application servers 112, 114 may be running Linux—Red Hat Enterprise operating system software 116 as shown. The social b2b network marketplace unit 104 may further comprise a well known Apache Web Server 118, a known PHP 5.2.13 120 installed as well as a well known MySQL 5.0.77 122 and these provide the operating environment for the social B2B network marketplace that is running a social unified database 124 which allows the system to provide an integrated combination of a transaction enabled storefront and marketplace combined with the social connectivity and communication structure to provide an integrated connectivity service between companies and a communication service within a company account on the system but also between companies and filtered depending on the demand of level of privacy and integrity.

The system, in one embodiment, may be a software-as-a-service (SaaS) in the cloud and is protected by Firewall(s) and SSL encryption. The Firewall(s) may be a Cisco ASA5500 series firewall and the SSL Service is a Versign SSL encryption license and may encrypt every single page of the social B2B marketplace for security reasons. The system may also be implemented using other architectures such as a client server model, a hosted model, a cloud server model, a mainframe/terminal model and the like and is not limited to any particular architecture.

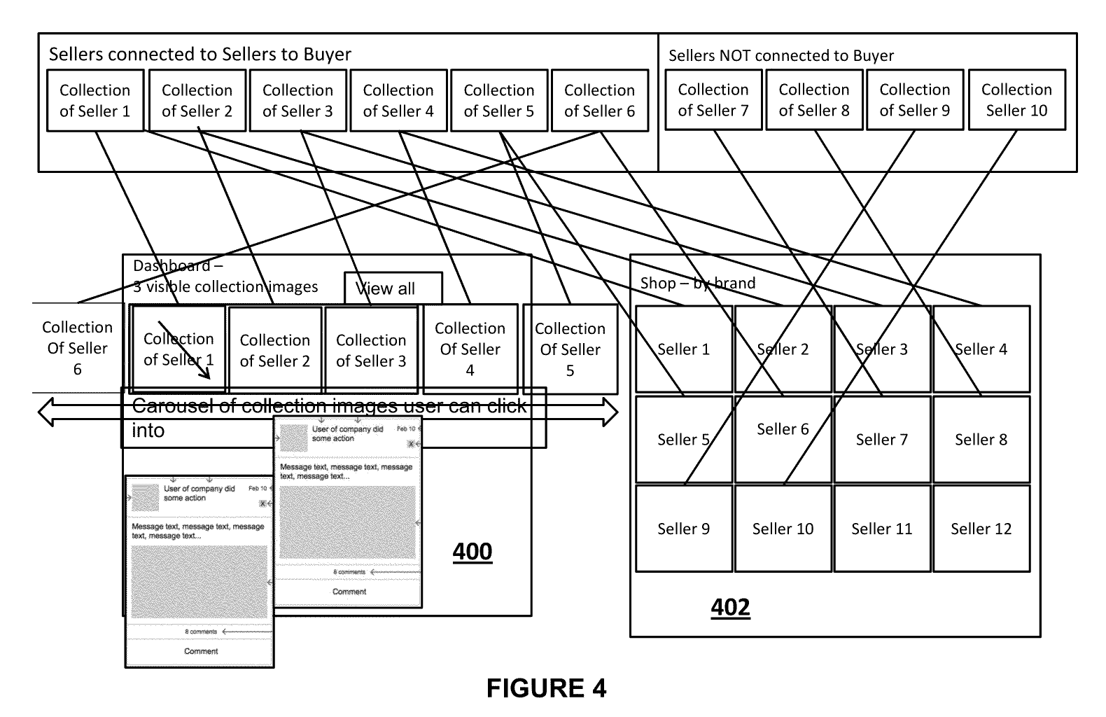

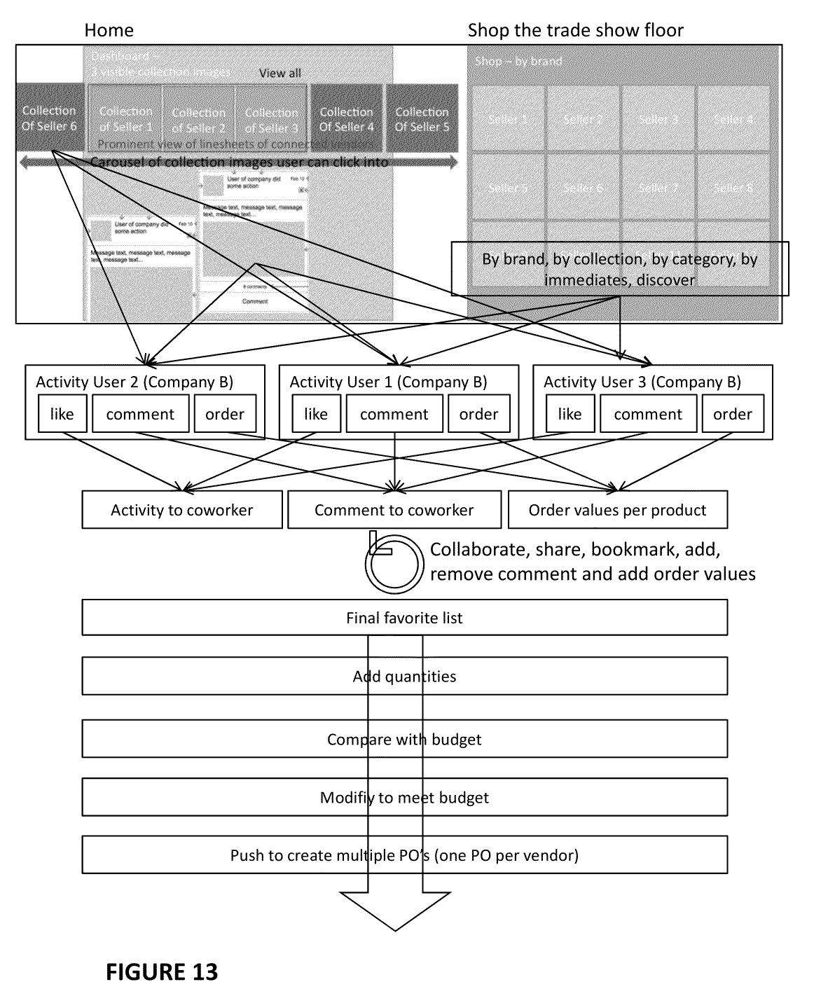

To provide the transaction-enabled storefront and marketplace combined with the social communication structure, the social network and marketplace unit 104 may further comprise one or more units 126 and an executive services unit 128 that provide the services and features. In one embodiment, each of the units 126 and the executive services unit 128 may be implemented as a plurality of lines of computer code that are executed by the one or more applications servers and database servers of the system. The units 126 may include a registration unit 126a that handles the registration of one to many users per company accounts and accounts of the system, a connectivity unit 126b that handles the connections between 2 or more companies on Balluun to create a private b2b network 102, a profile pages unit 126c that handles the company profiles pages as described below, a multilevel feeds unit 126d that handles the multilevel feeds as described below in more detail, a storefront unit 126e that generates and manages the storefront of each company on the social b2b marketplace, an inventory management unit 126f that manages products of a companies storefront and it's inventory, a shopping cart unit 126g that generates and manages the shopping cart between a buyer account and a seller account to allow the buyer to buy from a dedicated seller company storefront on balluun, a checkout unit 126h that generates and manages the checkout process of a shopping cart of a buyer from dedicated seller storefront, a CRM unit 126i that provides CRM services and features to the seller account based on his storefront as described below, a manage order unit 126j that manages orders for services and goods of the transactions (seller and buyer view) and provides a dynamic order template for ordering, a payment unit 126k that manages the payment process between seller and buyer on the social b2b marketplace with the API's into 3^{rd} party payment solutions (PayPal and other comparable third party payment solutions), a business intelligence unit 126i that provides typical business intelligence features to the marketplace, a recommendation engine that matches companies based on database records together. For example, the recommendation engine provides company matching based on a recommendation algorithm (for instance: build a recommendation service—seller>clothing>street wear to buyer>clothing>street wear for instance)+social relationship (social graph) of 1st, 2nd and 3rd degree of relationships.) The units 126 further may include an activity streams unit 126m that generates and manages the activity streams (described in more detail with reference to FIGS. 13 and 19-20 in U.S. patent application Ser. No. 13/197,669 (“'669 Application”) filed on Aug. 3, 2011 which is incorporated herein by reference) and a private messaging unit 126n that generates and manages the private messaging that is described in more detail with reference to FIGS. 21-33 in the '669 Application.) The units 126 and executive unit 128 combine a mix of features and functionality to provide the service. Each of the features and functionality takes advantage of the unified social database of social, company, product and transaction related data and delivers the required feature output as a user interface to the user. The structure filters the service and provides the required subset of the features as a buyer account, a seller account and a master/admin account (balluun master account) or just based on the features subscribed which are described below in more detail. The units 126 further may include a tradeshow component 126o that translates a physical tradeshow into a virtual tradeshow using the resources of the social marketplace system. The details of the tradeshow component 126o are shown in more detail in FIGS. 4-11 described below and Appendix A that show a number of example user interfaces of the tradeshow component functionality.

Using the social B2B network marketplace, a company or company division can create a company account with one to MANY employees under this company account. In other words, each company account on the system consists of a Company Profile and a sub Profile structure for every single employee as well. The relationship between employees within one company are therefore all related with each other and represent one company on the system. Employees can be added to a company account at any time. Furthermore, a company can invite and connect with any company which has an account on the social B2B system. The system, for example, can connect a manufacturer-manufacturer relationship, a manufacturer-wholesaler relationship, a wholesaler-wholesaler relationship, a wholesaler-retailer relationship, a wholesaler-reseller relationship, a retailer/retailer relationship, a reseller-reseller relationship and/or a wholesaler-retailer/reseller relationship.

The connect works by one company inviting another company (see FIGS. 34-39 of the '669 Application for examples of the process for inviting a new company) and the invited company confirms the invitation request (see FIGS. 40-42 of the '669 Application for examples of this process). With the system, as soon as two companies are connected, they can communicate with each other using the multi-level feeding structure and/or private messaging or conduct business with each other (ecommerce transactions). In this process, the activity notifications (described below in more detail) are being generated to each company based on the required connectivity. Some of the announcement activity streams can also go to an unconnected crowd of people known as the ‘public’. In addition, a company which invited multiple companies to join it's network is maintaining it's own B2B community on the system as well. Furthermore, there can be many independent B2B communities relative to a given company. The community can be all connected businesses or a sub-group of coworkers and/or it's employees grouped into a dedicated group.

The B2B network marketplace has the multi-level feeding structure. In the Company Wall of the B2B network marketplace (for inter and intra company conversations), the system may provide to post: a public filter that filters for everyone on Balluun (twitter like advertising/blogging); a partner filter for Business 2 many Businesses (all my business connections); and a coworker filter for intra company conversation (all my coworkers). In the My Wall portion of the B2B network marketplace (for inter & intra conversation (P2P, P2manyP) for post's, the system may provide: a public filter that filters for everyone on Balluun (twitter like advertising/blogging); a partner filter that filters for business 2 many Businesses (all my business connections); and a coworkers filter that filters for intra company conversations (all my coworkers). The My CoWorker Wall portion of the B2B network marketplace is for inter & intra conversation (P2P, P2manyP) with only threads towards or with that particular coworker involved). The system also provides a Partner Wall in a My Partner portion that is for inter conversation (private B2B) for only threats between me or my company with that particular partner. The system also has an Employee Wall that is part of the My Partner portion of the system that contains messages about inter conversation (private B2B personal) with only threads between me or my coworker with that particular partner employee. The system also has an ecommerce shopping cart check out process that provides inter conversation (private B2B object-related) which are conversations between seller and buyer related to this transaction. The system also provides My Company Opportunity that provides inter conversation (private B2B object-related) which are conversations between seller and buyer related to this opportunity. The system also have ecommerce myorders feeds that are inter conversation (private B2B object-related) between seller and buyer related to this order and orders/manage orders feeds that are inter conversation (private B2B object-related) between seller and buyer related to this order. The system may also have a customer Service feed that is an inter conversation (private B2B object-related) between seller and buyer related to this transaction. The system may also provide filtering of the messages that is described below with reference to FIGS. 15-16 of the '669 Application. The B2B network marketplace also has the multi-level activity streams. Activity streams are user generated activities which are mixed into the social feed. Users can respond to activity streams as they can to postings, which makes activity stream an integrated part of social feeds and allows engagement. In more detail, when a user is doing something or 2 companies are connecting or transacting, the system creates activity streams which flow into the social feed structure indicating what is happening on the system based on activity. The activity stream is part of the social feed structure allowing users to even respond back with a response feed to an activity stream and cause interaction with other users. Examples of the multi-level activity streams are:
Company Wall
   Global B2B (Community/Public)—“Company X’ just joined Balluun’,
      ‘Company X just added a product to it's storefront’ (privacy setting of Product is ‘Public’, ‘Company Y just activated it's storefront’
   Partner (Business Connection)—‘Company X just added a product to it's storefront’ (privacy setting of Product is ‘Partners’)
   Transaction—‘Company’ A just created a shopping cart with you’, ‘Company A just submitted order to you’, etc (a private object-related activity stream between seller and buyer)
   Company (Co-Worker)—‘Coworker B just joined your team on Balluun, —‘Company X just added a product to it's storefront’ (privacy setting of Product is ‘Coworker’, ‘Coworker B just uploaded a new logo for your company’
My Wall
   ‘You just joined Company Z on Balluun’
Co Worker Wall
   ‘Coworker B joined your team on Balluun’, ‘Coworker B uploaded a new logo for your company’
My Partner>Partner Wall
   ‘Company X added a product to it's storefront’ (privacy setting of Product is ‘Partners’)
My Partner>Employee Wall only threats
   “Partner Employee Name’ uploaded a new image to his wall’
E-Commerce>shopping cart/checkout process
   ‘You added product xyz to your cart at Company A’
My Company>Opportunity
   ‘Company X just created a shopping cart on your storefront’
E-Commerce>My Orders
   ‘Company X just submitted purchase order to you’
Orders>Manage Order
   ‘Company X just made payment to purchase order xyz’
Customer Service (future)
   ‘Company X just flagged transaction for customer service review’

The social network marketplace unit provides social networking in and among the users/partners/buyer/sellers of the social marketplace unit and all of the other users/partners/buyer/sellers of the social marketplace unit. The social marketplace unit enables private messages between one or more of the parties. The social marketplace unit ‘also’ enables a message broadcast to all partners of a user so that, for example, Company A can broadcast messages to Company B, Company C and Company D and these also permit all of the parties involved in the broadcast message to respond to all of the other parties.

The social network marketplace unit also enables communications between a partner and another partner. For example, Company A can communicate with Company B, but Company C cannot gain access to the messages between Company A and Company B. Thus, the social marketplace unit enables private conversations between users of the social marketplace unit (private B to B).

The above described social network marketplace may be used to implement a system and method for the authentic translation of a physical tradeshow in which the wholesale product planning and buying experience is ‘enhanced’ as a digital service with re-stocking planning and mass purchase order creation services. The system may implement the typical “at the trade show” experience of a buyer using mobile apps and/or the shopping the tradeshow floor via the web application. The web application may be used if the buyer does not go to the show but does it online or the web application may be used when the user has come back from the show and then uses the web app to do any follow up from the tradeshow. The system also may include a system/process to structure the collections/products showcased, identified and bookmarked and prepared for ordering across multiple vendors. The system also may allow collaboration within the retail buyer team about the products added to the favorite list, then short listed for re-stocking, validate with available budget and then send multiple purchase orders to various vendors.

The system also may structure the retail-vendor relationship as social business relationships so that each retailer, for example, is able to view vendors booths spaces or products/collections based on social network relationship levels as described above with the required privacy requirements so that wholesale prices are only getting exposed when a network relationship exists and the system only shows open accessible booth spaces and locked up ones. The system may also permit stacking line sheets, organizing and liking products into a favorite list using web and mobile apps, sending liked product activities to coworker so that the buyer team can collaborate and share discussions. The system may also permit the retailer to remove products from a favorite list to create a short list, compare the short list with buyers available budget and then send off purchase orders for the products/merchandise. The system and method for the authentic translation of a physical tradeshow may include a web-based version and/or a mobile device based version, each of which is described below in more detail.

Web Implementation of the System

Using the social network marketplace above, the vendors are networked in a buyer's network and the active collections with it's respective products of each vendor (the connected vendors) are showing prominently on buyer's dashboard with easy access to each of the connected vendors line sheets and/or product collections, with access to vendors profiles and access to product overviews on the storefronts of each vendor. In this implementation, each of the features described below and the user interfaces are displayed in a web page that is displayed on a buyer/retailer's computing device using a typical browser application being executed by the processor of the computing device. Using the system, the buyer receives a filtered version to the line sheets/product collections of each of the connected vendors that the buyer presently considers active vendors, such as because the buyer is usually repetitively buying from them—season after season and therefore is in a network relationship. It's based on the network relationship. User get's to see 3 collection main images at a time and can by pressing arrow right or arrow left scroll through other linesheets of his connected vendor or click into ‘view all’ which takes him into the list of all available linesheets of his connected vendors.

The filtering performed by the system reduces the “noise” and the mass of brands/manufacturers that the particular buyer is ‘not’ doing business with. At a trade show, it is quite overwhelming to see thousand and thousands of products from hundreds or thousands of vendors showcasing their brand and products on the marketplace.

The social business to business marketplace system and method, described in U.S. patent application Ser. No. 13/197,669 which is incorporated herein by reference, provides the architecture and logic that provides the display of relevant information to a buyer based on the network relationship between the buyer and vendor. In addition, the social feed and activities of connected and opted in vendors on the social wall allows the users to also discover the activities of connected businesses/vendors and of new product collection activities or product activities that connected and opted in vendors have launched/added. Thus, the system provides an interactive way of exploring new information from connected/opted in vendors and allows distributed company and product news every day across the year in a social feed style.

In addition to the product collections/linesheets access that the buyer receives on his dashboard/home from connected vendor collections/activities/products, the system offers a ‘shop’ the (virtual) trade show (floor) experience which allows a buyer to scroll through the list of company tiles (by brand) which is representing a virtual walk the trade show floor. The virtual walk may allow the retailer/buyer to identify/bypass/discover brands, see product collections/linesheets stacked in one long view. The system may also illustrate the stack of all available paper linesheets/product collections that the user could collect in a digital form (by collection), but made online visible for the user to scroll through, filter and search. The system may also show products in various views (immediate product view (immediates) and product display based on product category (by category)) so that the buyer can more easily filter down the huge amount of available products. Examples of the user interface are contained in Appendix A that are incorporated herein by reference.

In addition, the system may allow the buyer to also discover products on the site with a serendipity effect with a ‘discover’ page. Examples of this user interface are contained in Appendix A that are incorporated herein by reference. While the previous views described above have been structured by brand, by collections, by category and by immediates, the discover page is a random display of products in one large stream. The discover page within the shop page (will also become available in dashboard in the future) uses all product activities being created from every seller in a random stream of product activities which allows retail buyers to scan in an easy and fun way through the endless amount of product activities. Products being liked by users may push products back up into the stream and this way re-activated for view. User can also filter product activities that are most liked to see the products which have been liked the most. This provides a democratic way of creating a trend insight of which products are most liked for others to identify. To make this service work, the system utilizes the activity functionality of the commonly owned and co-pending U.S. patent application Ser. No. 13/197,669 which is incorporated herein by reference of a social business to business marketplace.

From the various views described above, there is a capability that allows the user to memorize products for future review or to prepare future orders. This capability of bookmarking products into a favorites list using the mobile app and/or the web application may be done by simply pressing a like button/a heart button so that the user may add product into a favorite list of products arranged in an order from the various vendors. Examples of the user interface are contained in Appendix A that are incorporated herein by reference. By bookmarking (liking) a product, an activity is being shared with the coworkers in the same retail business to announce that he added this product to the favorite list. By doing so, the user starts an activity and/or a conversation with his coworker about this product utilizing the social business to business marketplace infrastructure. The system this allows the user to share and engage with a buying team to share the products he/she likes and to collaborate on it in a social collaboration style without the need to leave the application and to leave the relevance to the shopping experience in one single purpose built tool. The bookmarked product(s) is available to both the person who bookmarked the product as well as his team at the company account on the system so that each of the employee of this company account can see the bookmarked products and can add and remove these products to that favorite list. With the combination of this service and the coworkers having access to this list supported by the product activity and the related collaboration between the coworker, the system is supporting the need to add/remove products, basically merchandise re-stocking, and end up with a short list of products which the retail buying team can then settle on. The order quantities per product on any available size/color combination per product, for all products for one vendor, for all vendor combined allows, to also compare with the budget the buyer team was entering before they were starting off the buying season for that next season. The values entered and saved, compared with available budget, then allows the retailer buyer team to push ‘create all PO's button which will populate all order purchase orders in one go.

FIG. 4 illlustrates an example of a configuration of a virtual tradeshow including a retailer home page 400 and an industry focused brand page 402 that may be implemented using the tradeshow component and the social business to business (B2B) network marketplace. The system may generate a home page for each retailer who is part of the social business to business (B2B) network marketplace and the retailer home page 400 for each retailer may include a prominent display of the brands products that the retailer is connected with. The industry focused brand page 402 may display products from a number of different sellers as shown similar to the way one would shop at a physical tradeshow floor. As shown in the retailer home page, each retailer/seller may have more than 1 collection (linesheet) displayed in the home page and the homepage may have a carousel that rotates through the collections of the seller. As shown in FIG. 4, the different collections of the sellers may appear in the retailer home page (if that particular retailer is connected to that seller) and also in the industry focused brand page 402. In one implementation, the retailer home page may display three collection images at one time. The home page 400 and the page 402 may be configured so that each collection (linesheet) can be become visible (and orderable) and/or disappear with different release schedules for each collection so with this the collections up there can appear and disappear dynamically based on launch and expire dates for the collection.

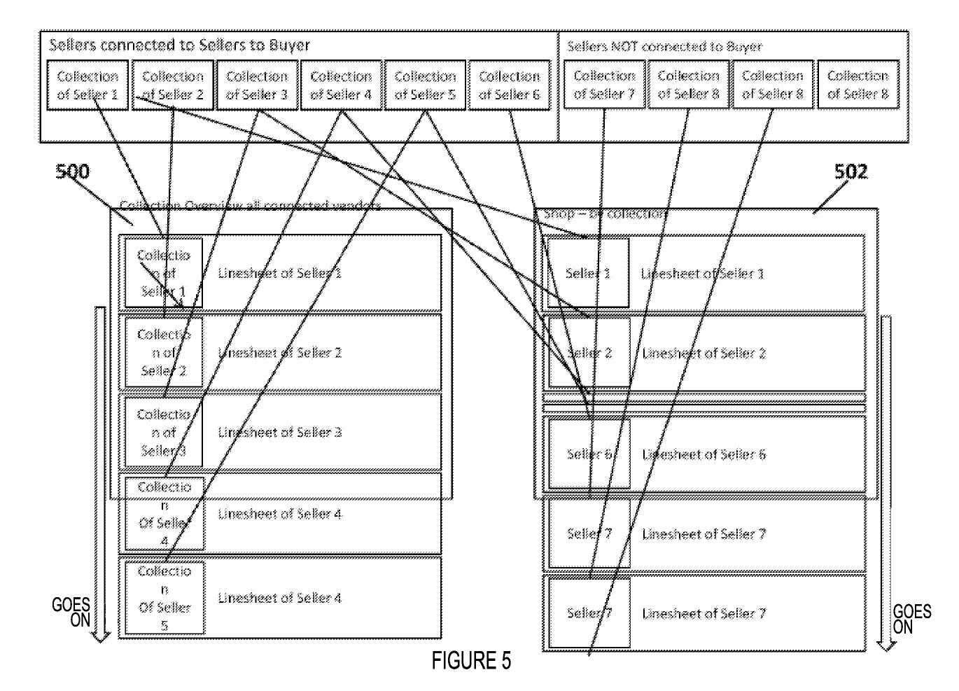

FIG. 5 illlustrates an example of a configuration of a virtual tradeshow including a retailer linesheet overview 500 and an industry focused collection page 502 that may be implemented using the tradeshow component and the social business to business (B2B) network marketplace. The system may generate a retailer linesheet overview 500 for each retailer who is part of the social business to business (B2B) network marketplace and the retailer linesheet overview 500 for each retailer may include a prominent display of the collections/linesheets of the sellers associated with the retailer. The industry focused collection page 502 may display linesheets from a number of different sellers as shown similar to the way one would shop at a physical tradeshow floor. In the example user interface in FIG. 5, a certain number of linesheets are shown, but the user interface may display an infinite number of linesheets. As before, the page 500 and the page 502 may be configured so that each collection (linesheet) can be become visible (and orderable) and/or disappear with different release schedules for each collection so with this the collections up there can appear and disappear dynamically based on launch and expire dates for the collection.

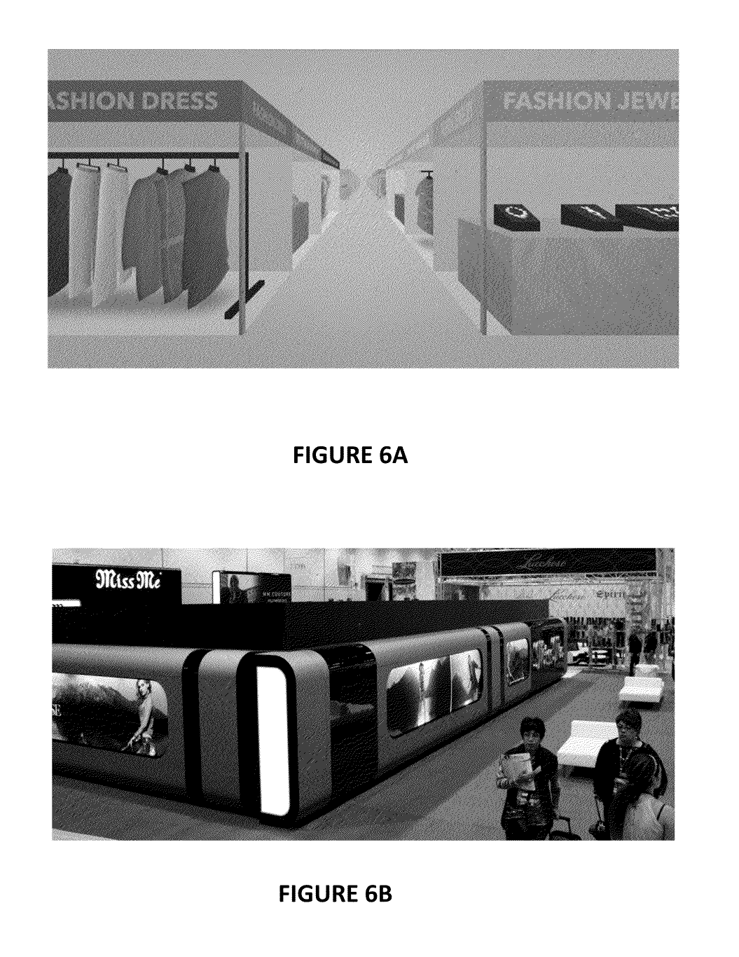

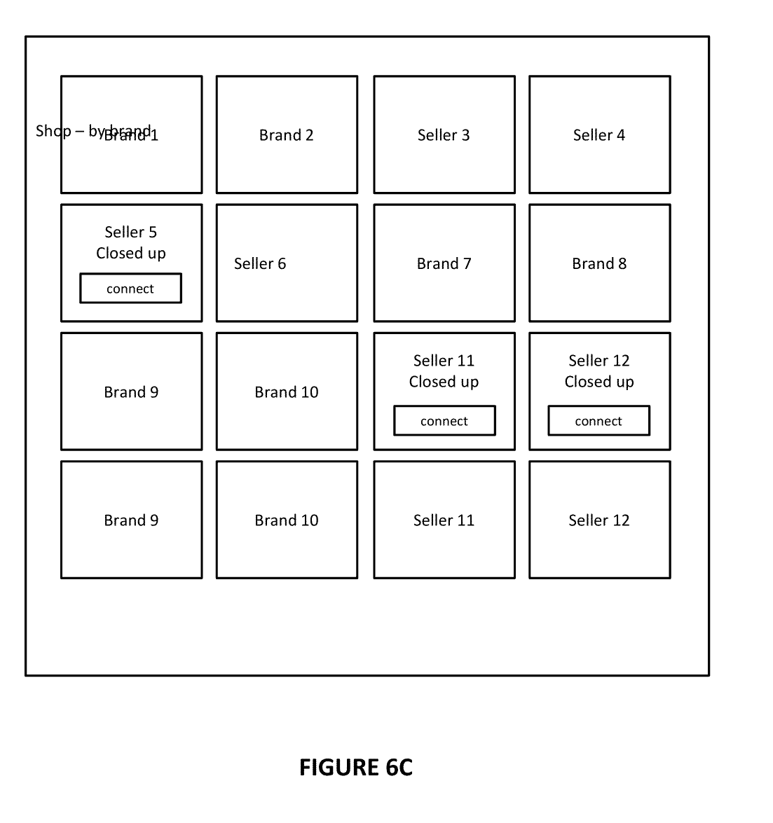

FIGS. 6A-6C illustrate examples of a virtual tradeshow user interface including open booth spaces, closed up booth spaces and a layout map of the virtual tradeshow, respectively. More specifically, FIG. 6A show open booth spaces in the virtual tradeshow system, FIG. 6B shows closed up booth spaces in the virtual tradeshow system and FIG. 6C illustrates tiles in by brand in the shop pages in the virtual tradeshow being hosted by the tradeshow component and the social business to business (B2B) network marketplace. The virtual tradeshow may have three states including: 1) booth spaces (open or closed appears as open) of a vendor that the particular retailer is connected with in the social business to business (B2B) network marketplace; 2) limited open booth space of vendors that the retailer is not connected with (but doesn't show proprietary information like prices unless connection is made); and 3) closed up booth space of a vendor where a connection has to be made to open up the store to retailer based on the connection relationship. Thus, a vendor with whom the retailer has not made a connection may be shown as the closed booth in FIG. 6B. The layout in FIG. 6C, for each retailer, may show the open sellers (that the retailer has already connected to in the social business to business (B2B) network marketplace) and the closed sellers.

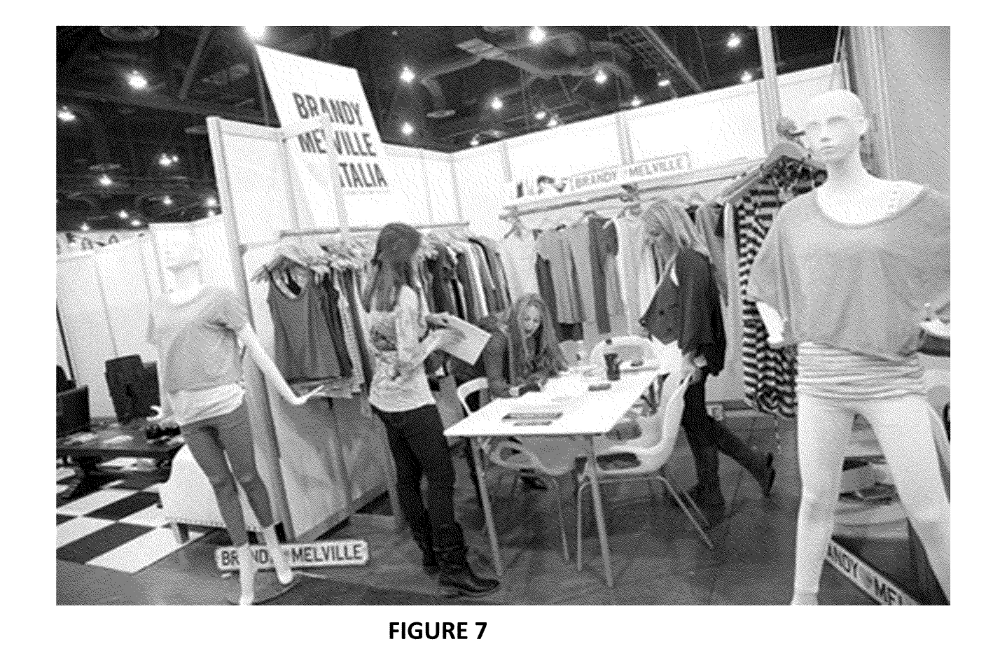

FIG. 7 illustrates an example of a single booth space at a virtual tradeshow that may be implemented on a mobile application for the virtual tradeshow. The social business to business (B2B) network marketplace and the tradeshow component may provide the following services that replace/support the physical space including: 1) an online Storefront; 2) Linesheet/Collection electronically; 3) Lookbook functionality; 4) Purchase order taking electronically; 5) collaboration in person while using the social business to business (B2B) network marketplace system (showroom mode); and/or 6) collaboration between retailer and sales rep through the social business to business (B2B) network marketplace tradeshow application. The lookbook feature is a type of wishlist that allows a buyer to indicate an item from a collection that the buyer would like to purchase. The virtual tradeshow provided by the social business to business (B2B) network marketplace may provide an authentic translation of a tradeshow/Showroom experience in one or more of the following ways: 1) collaborative experience while shopping, taking orders or managing orders; 2) allowing to take notes, to share and to communicate ahead of the show, during the show or after the orders; 3) collaboration and note taking within the merchandise process of retail buyer with his team over multiple devices with multiple user accounts within the same company account but also between retail buyer and his vendor; 4) pricing information are only getting granted once a connection is made similar as if the retail buyers inquires a pricing sheet at the tradeshow with the sales rep and the sales rep is handing it over, which can be seen as an informal connection request; and/or 5) like at the tradeshow where a buyer can walk by the booth space and gets a glimpse of the merchandise and if interested can start a conversation, on social business to business (B2B) network marketplace scan's the brand tiles and it's collection to reflect the same experience.

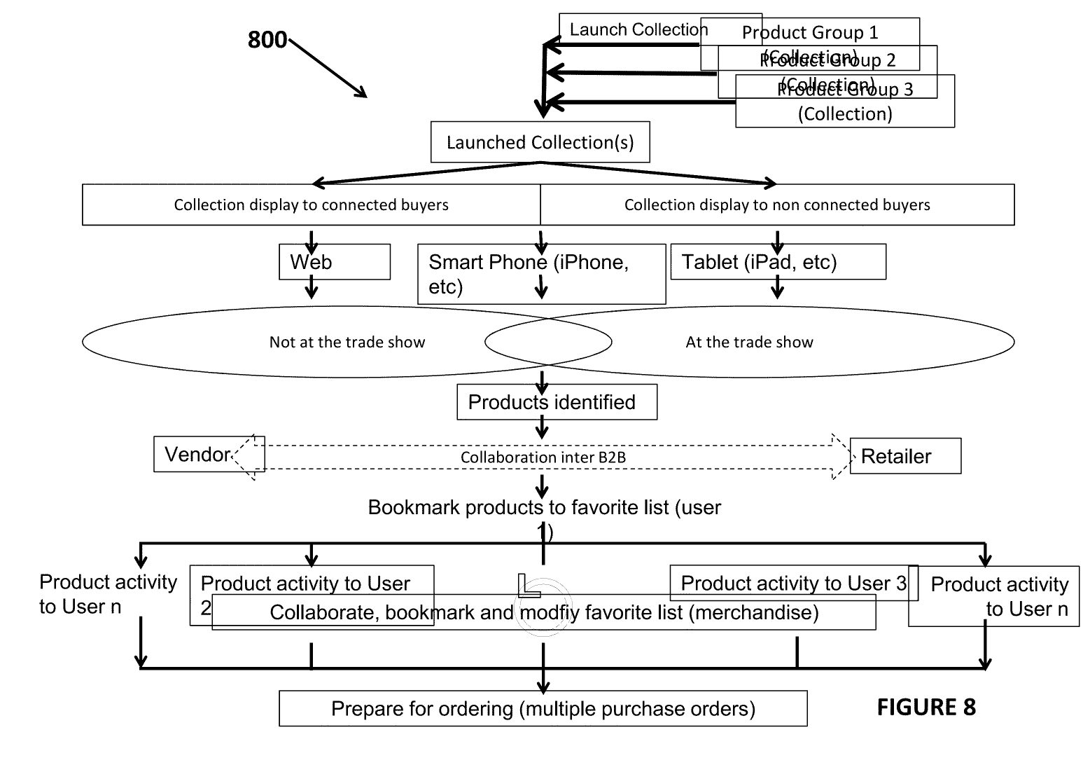

FIG. 8 illustrates a wholesale order planning and buying method 800 that may be implemented using the tradeshow component and the social business to business (B2B) network marketplace. As shown, a retailer may launch one or more collections (product group 1, product group 2 and product group 3 in the example in FIG. 8) which then become launched collections in the tradeshow system. The launched collections may be one or more collections displayed to buyers who are connected to the retailer in the social business to business (B2B) network marketplace and one or more collections displayed to buyers who are not currently connected to the retailer. As shown in FIG. 8, each buyer may use a web application, smart phone or a tablet to review the collections either at the trade show or at a location remote from the trade show. As a result of the review of the collections, products may be identified and/or bookmarked to a favorite user. The social business to business (B2B) network marketplace and the tradeshow component may then initiate one or more product activity streams with each user that may result in one or more purchase orders being prepared.

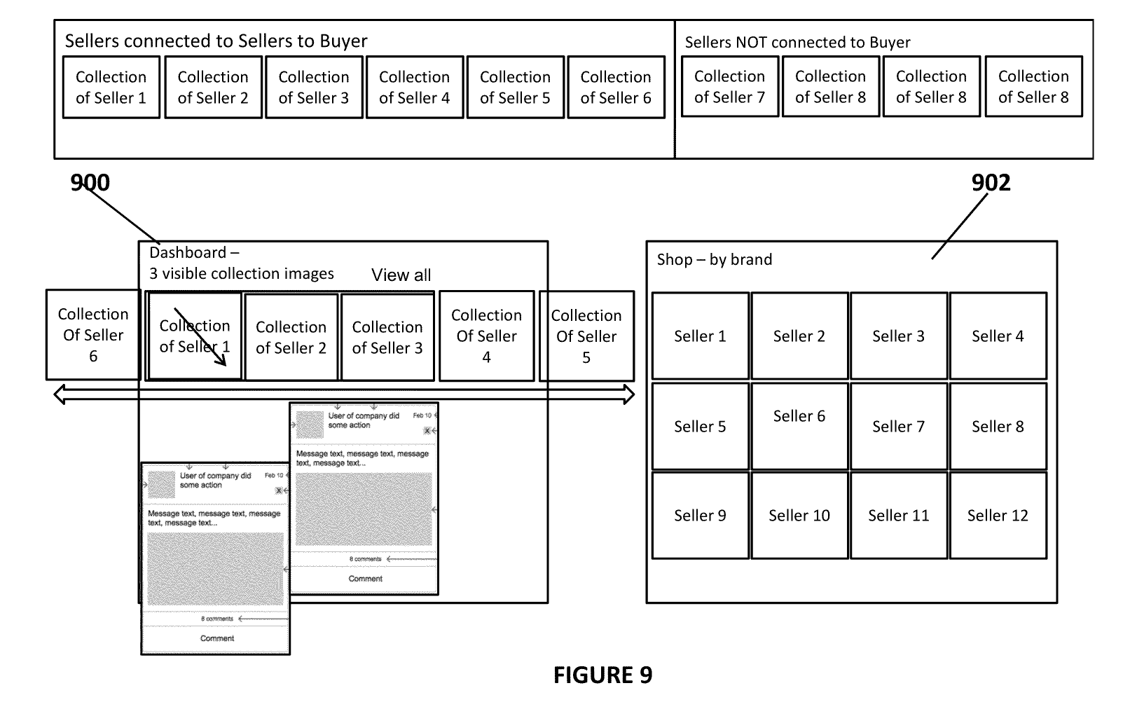

FIG. 9 illlustrates an example of a configuration of a virtual tradeshow including a dashboard 900 and a shop by brand page 902 that may be implemented using the tradeshow component and the social business to business (B2B) network marketplace. The system may generate the dashboard 900 for each retailer who is part of the social business to business (B2B) network marketplace and the dashboard 900 for each retailer may include a prominent display of the linesheets of the vendors/sellers connected to the retailer using the social business to business (B2B) network marketplace. The shop-by-brand page 902 may display products from a number of different sellers as shown similar to the way one would shop at a physical tradeshow floor. As shown in the dashboard 900, each retailer/seller may have more than 1 collection (linesheet) displayed in the dashboard and the dashboard may have a carousel that rotates through the collections of the seller. As shown in FIG. 9, the different collections of the sellers may appear in the retailer dashboard (if that particular retailer is connected to that seller) and also in the shop-by brand page 902. In one implementation, the dashboard may display three collection images at one time. The dashboard 900 and the page 902 may be configured so that each collection (linesheet) can be become visible (and orderable) and/or disappear with different release schedules for each collection so with this the collections up there can appear and disappear dynamically based on launch and expire dates for the collection.

Mobile Implementation of the System

The system may also be implemented using a mobile application (mobile app) that has the same basic functions as the web version described above. In this implementation, each of the features described below and the user interfaces are displayed in a mobile app user interface that is being executed on a buyer/retailer's computing device that may include a tablet computer or smart phone. The mobile app supports the same experience the user is getting on the web application but in a mobile form that is offering additional, valuable use cases. For example, as the retail buyer walks the trade show floor, the mobile app allows the buyer/retailer to bookmark products, take notes and/or engage with sales representatives of brands/manufacturer at the trade show floor using the app to capture the product, the information or the conversation and initiate the dialogue. It also allows retailer to prepare purchase orders on the go. Unlike typical mobile applications focusing on creating purchase orders, the balluun mobile app has the showroom mode that allows the seller and the buyer to fill out a digital purchase order using the Showroom mode in the mobile app as well, which is described in the previous patent application about collaborative checkout . . . . Examples of the user interface are contained in Appendix A that are incorporated herein by reference.

The mobile app allows a retail buyer to walk the tradeshow floor and look up the vendors product collections/linesheets while he is visiting their booth at the tradeshow floor. The user may also click into the collections product overview or product details page and bookmark (like) products he likes. By doing so he is adding each bookmarked (liked) product into his favorite list of products and also causes a product activity stream, similar as on the website which is getting shared with retail buyers buying team who is either also on the show walking another area or is at home and can see what products the coworker at the tradeshow floor is bookmarking. Since the product activity is collaborative within the social business to business marketplace, the user can start a conversation, such as mobile app to mobile app or mobile app to website, with other users within the same company account. The experience above is similar to what the user can do on the web application by bookmarking to the favorite list, but because he walks the floor and seeing the real product, the experience gives more context and eliminates the requirement to make notes about certain products. Furthermore, because the interaction is captured as a bookmarked product, the collaboration on the product activity with co-workers gives context to the favorited products. The mobile app also allows the user to take pictures of products from the tradeshow and either send it to himself/coworkers with comments in a social feed into companies company wall on the social B2B system. The user may also send the image, about a given product for which he needs a proposal, attached to a feed from his mobile device to the vendor's sales rep. he is talking with right at the show. The sales representative gets the feed request for the inquiry right from the mobile app and can work it off later at his convenience. This all illustrates how the mobile app of integrated social business to business marketplace and method with it's multi-level feeding architecture (described in more detail in the co-pending patent application referenced above) with the enhancement of bookmarking products into a favorite list or simply sharing product shots at the booth allows retail buyers to engaged with their retail buying team or vendor and how vendor can engage with his retail buyer in a way which eliminates the old way of making non-contextual comments on paper or notebooks.

In addition to bookmarking products into favorite list, the mobile app also allows a retail buyer to visit a vendors booth, filters the many product collections/linesheets to exactly the ones of this vendor and click into collection product overview or product detail page. The retail buyer may then create a purchase order on the go by entering the quantities for the product in it's available offering which automatically creates a purchase order on his account on the social B2B network system with this vendor. Similar to the showroom Mode described above in the web application, the user can add a product and an order template which is getting created dynamically from the database record. In addition, an order table is getting assembled on the fly by showing a table of sizes and colors per product available. The user simply enters the quantities he is interested in buying and saves the values. The user can do this product by product of vendors collection while he is visiting the vendors booth even without the sellers support. The user may also use the showroom mode that allows the sales rep. and retail buyer to take orders together, but retail buyer might decide that preparing purchase order is just sufficient to prepare on his own and then complete order by either follow up with vendor or simply choosing vendors terms and submitting the order. While creating the purchase order can be done on the mobile device, the checkout of the purchase order form can be done via mobile also, similar and seemless as if user would be on the web application. This illustrates how integrated mobile app and web application work with each other and are a ecosystem of services for retail buyer to conduct his business on or away from the tradeshow.

This above process can be repeated across multiple sellers walking from booth to booth, which ultimately allows the retail buyer to prepare everything needed on a single mobile device without the need of any other application to get the job done. The mobile app may support all requirements that the user is facing in making notes, memorizing products in favorites, sharing it with coworkers or vendors, or preparing purchase orders which then of course can be managed on the web but also mobile app through the whole manage order process using the order management system described in copending patent application with the title Collaborative Checkout and Order Management in Social Business to Business Marketplace System and Method with the Ser. No. 13/584,700 filed on Aug. 13, 2012 and incorporated herein by reference.

Since the mobile app allows the user to enter a season buying budget, the mobile as well as the web application allows the user to review the available budget and provides the user with a display of how the user is doing against budget before starting to prepare re-stocking or before creating purchase orders. Examples of the user interface are contained in Appendix A that are incorporated herein by reference.

The mobile app also may allow a retail buyer to review favorite list of products bookmarked from the mobile app, the same way as from his web application. The benefit is, that even while the retail buyer is at the show, the retail buyer can review the bookmarked page of products listed and can start a conversation with his coworkers or his vendors product by product or simple start creating a purchase order from the products in that shortlist. The integrated social application allows also here again to send product activities/feeds to coworkers or vendors sales rep to continue the discussion. No longer there is a need to disrupt the context by managing the conversation over traditional email anymore or planning the merchandising process over a stack of paper linesheets and paper purchase orders.

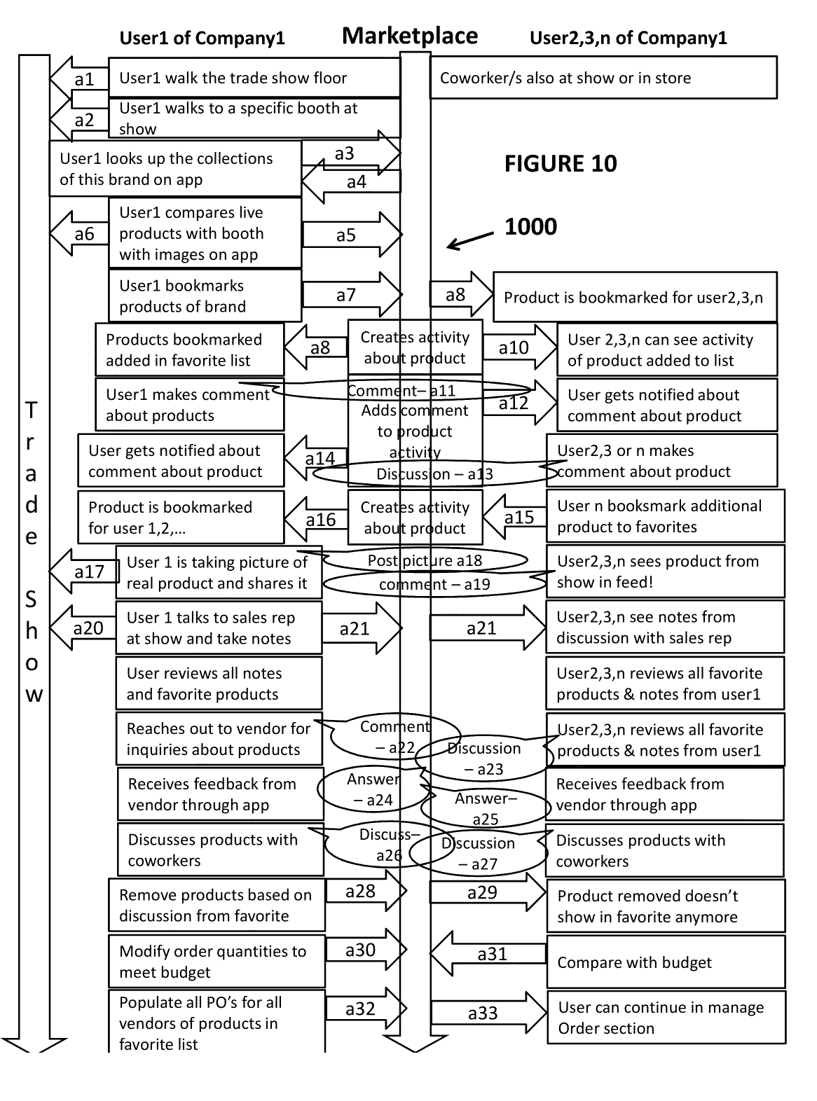

FIG. 10 illustrates a tradeshow workflow 1000 in the social business to business (B2B) network marketplace using a mobile application. The workflow may involve at least one retail buyer at the trade show (User 1 of company 1 in the example in FIG. 10) and coworkers that may be at the show or back at the store (Users 2, 3, . . . , n of Company 1 in the example in FIG. 10.) The tradeshow component and the social business to business (B2B) network marketplace (shown as marketplace in FIG. 10) facilitate the communications and interactions of the users of the company at various stages of shopping at the virtual tradeshow.

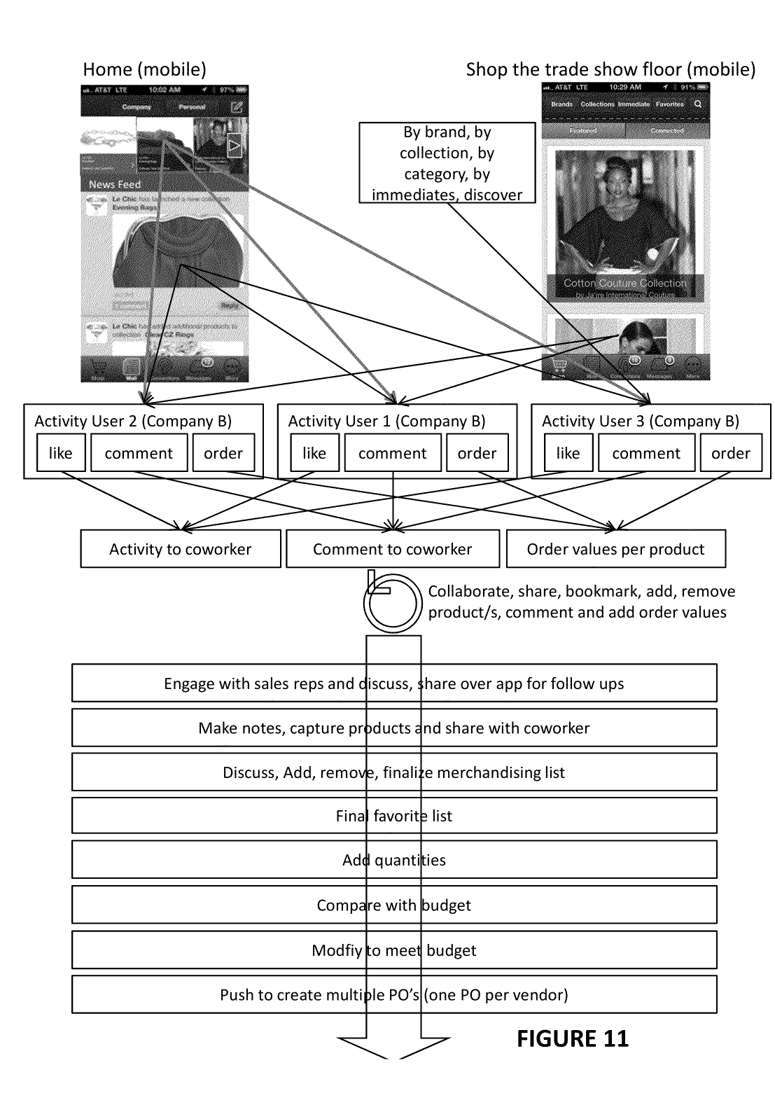

FIG. 11 illustrates another tradeshow workflow in the social business to business (B2B) network marketplace using a mobile application in which a user at the tradeshow (home mobile) and a user at the tradeshow floor (mobile) both shop at the tradeshow for a company (Company B in this example) with one or more users (User 1, User 2 and User 3 in this example.) Using the social business to business (B2B) network marketplace and the tradeshow component, each user of the company may have an activity stream and each user may like a product/collection, comment on an order/collection and/or order the product or collection over a computing device using the mobile application. The system may allow the users to generate an activity to a coworker, comment to a co-worker and/or order values per product. The user may also collaborate, share, bookmark, add, remove products and the like. The user may also carry out the tradeshow activities shown in FIG. 11 using the social business to business (B2B) network marketplace and the tradeshow component.

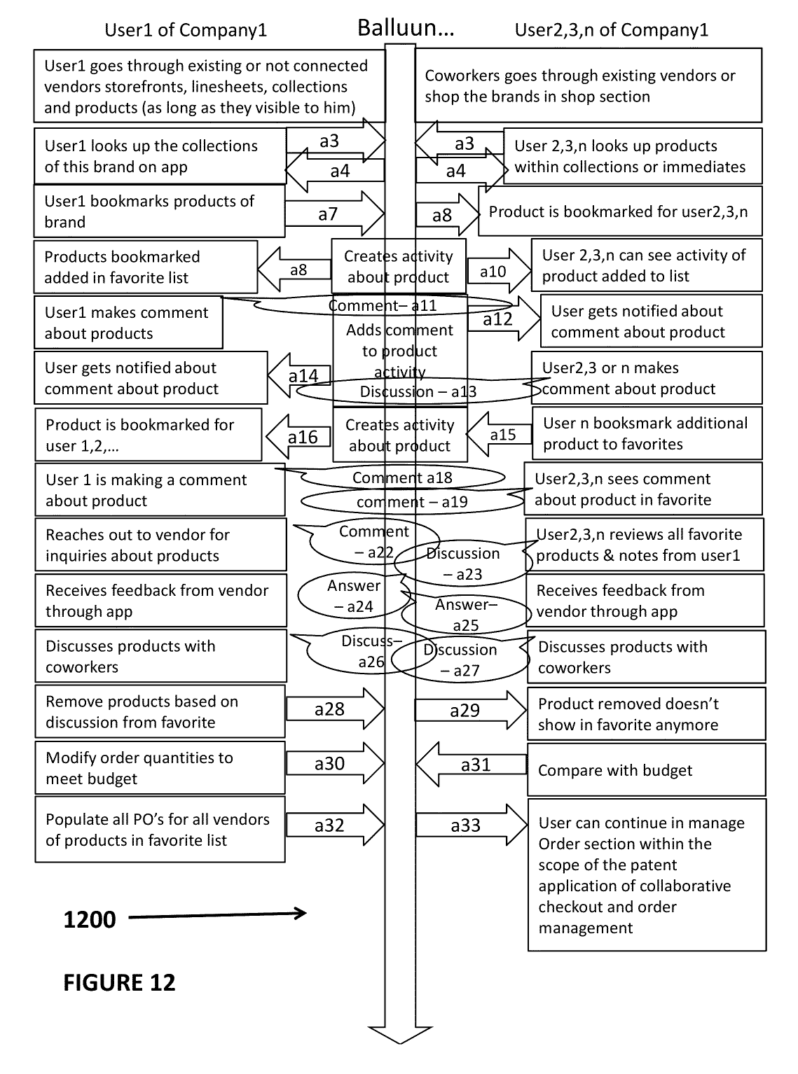

FIG. 12 illustrates a tradeshow workflow 1200 in the social business to business (B2B) network marketplace using a web application. The workflow may involve users who are not at the tradeshow (Users 1, 2, 3, . . . , n of Company 1 in the example in FIG. 12.) The tradeshow component and the social business to business (B2B) network marketplace (shown as marketplace in FIG. 12) facilitate the communications and interactions of the users of the company at various stages of shopping at the virtual tradeshow.

FIG. 13 illustrates another tradeshow workflow in the social business to business (B2B) network marketplace using a web application in which the users (User 1, User 2 and User 3 in this example) can browse collections using the web application (that may be displayed in a browser application of a computing device, for example.) Using the social business to business (B2B) network marketplace and the tradeshow component, each user of the company may have an activity stream and each user may like a product/collection, comment on an order/collection and/or order the product or collection over a computing device using the mobile application. The system may allow the users to generate an activity to a coworker, comment to a co-worker and/or order values per product. The user may also collaborate, share, bookmark, add, remove products and the like. The user may also carry out the tradeshow activities shown in FIG. 13 using the social business to business (B2B) network marketplace and the tradeshow component.

While the foregoing has been with reference to a particular embodiment of the invention, it will be appreciated by those skilled in the art that changes in this embodiment may be made without departing from the principles and spirit of the disclosure, the scope of which is defined by the appended claims.

1. A virtual tradeshow system, comprising:
a computer implemented social marketplace having a retailer and a buyer wherein the seller has one or more collections of items to sell at a tradeshow and the buyer may purchase from the one or more collections of items and wherein the social marketplace permits an interaction between the seller and the buyer in connection with the tradeshow;
a tradeshow component, implemented on the computer implemented social marketplace, that generates a tradeshow user interface comprising one or more of a retailer homepage, a shop by brand user interface,a retailer collection user interface and a shop by collection user interface;
the social marketplace having a retailer that is connected to one or more buyers, wherein the tradeshow component generates one of a open virtual booth user interface for each buyer that is connected to the retailer, a limited open booth that displays the one or more collections for each buyer that is not connected to the retailer and a closed booth that does not display the one or more collections for each buyer that is not connected to the retailer; and
wherein the social marketplace facilitates the tradeshow activities between the retailer and the one or more buyers.

2. The system of claim 1 further comprising one or more computing devices, each of which is configured to access the social marketplace and interact with the tradeshow component.

3. The system of claim 2, wherein each computing device has a processor, a memory connected to each other.

4. The system of claim 3, wherein each computing device has a browser application stored in the memory and executed by the processor that displays the user interface of the tradeshow component and allows a user to perform the tradeshow activities.

5. The system of claim 2, wherein each computing device has a mobile application stored in the memory and executed by the processor that displays the user interface of the tradeshow component and allows a user to perform the tradeshow activities.

6. The system of claim 1, wherein the social marketplace generates an activity stream for each user that interacts with the tradeshow component.

7. The system of claim 6, wherein the activity stream further comprises a like item feature, a comment on item feature and an order item feature.

8. The system of claim 1, wherein the social marketplace generates a purchase order based on the tradeshow activities.

9. The system of claim 1, wherein the tradeshow component has a lookbook feature that is a list of one or more items from the one or more collections that the buyer would like to purchase.

10. The system of claim 1, wherein the retailer homepage and the retailer collection user interface dynamically display the one or more collections.

11. The system of claim 10, wherein each collection has a launch date and an expire date and wherein each of the one or more collections displayed on the retailer homepage and the retailer collection user interface appear when the launch date has occurred and disappears when the expire date has occurred.

12. The system of claim 1, wherein the retailer homepage has a carousel feature that sequentially displays the one or more collections.

13. A method for providing a virtual tradeshow, comprising:
providing a computer implemented social marketplace having a retailer and a buyer wherein the seller has one or more collections of items to sell at a tradeshow and the buyer may purchase from the one or more collections of items and wherein the social marketplace permits an interaction between the seller and the buyer in connection with the tradeshow;
generating, by a tradeshow component that is part of the computer implemented social marketplace, a tradeshow user interface comprising one or more of a retailer homepage, a shop by brand user interface,a retailer collection user interface and a shop by collection user interface;
generating, by the tradeshow component, one of a open virtual booth user interface for each buyer that is connected to the retailer; a limited open booth that displays the one or more collections for each buyer that is not connected to the retailer and a closed booth that does not display the one or more collections for each buyer that is not connected to the retailer; and
facilitating, by the computer implemented social marketplace, one or more tradeshow activities between the retailer and the one or more buyers.

14. The method of claim 13 further comprising accessing, using a computing device, the social marketplace and interacting with the tradeshow component.

15. The method of claim 14, wherein interacting with the tradeshow component further comprises using a browser application to display the user interface of the tradeshow component and allow a user to perform the tradeshow activities.

16. The method of claim 14, wherein interacting with the tradeshow component further comprises using a mobile application to display the user interface of the tradeshow component and allow a user to perform the tradeshow activities.

17. The method of claim 13 further comprising generating, by the social marketplace, an activity stream for each user that interacts with the tradeshow component.

18. The method of claim 17, wherein the activity stream further comprises a like item feature, a comment on item feature and an order item feature.

19. The method of claim 13 further comprising generating, by the social marketplace, a purchase order based on the tradeshow activities.

20. The method of claim 13 further comprising providing a lookbook feature that is a list of one or more items from the one or more collections that the buyer would like to purchase.

21. The method of claim 13, wherein displaying the one or more collections further comprises dynamically displaying the one or more collections.

22. The method of claim 21, wherein each collection has a launch date and an expire date and wherein dynamically displaying the one or more collections further comprises causing each collection to appear when the launch date has occurred and causing each collection to disappear when the expire date has occurred.

23. The method of claim 13, wherein displaying the one or more collections further comprises sequentially displaying the one or more collections.
